(19) United States
(12) Patent Application Publication
(10) Pub. No.: US 2005/0021410 A1
(43) Pub. Date: Jan. 27, 2005

(54) System for handling refund of value-added tax

(75) Inventor: Markus Ostlund, Goteborg (SE)

Correspondence Address: HARNESS, DICKEY & PIERCE, P.L.C., P.O. BOX 828, BLOOMFIELD HILLS, MI, 48303, US

(73) Assignee: GLOBAL REFUND HOLDING AB, Molndal (SE)

(21) Appl. No.: 10/875,060

(22) Filed: Jun. 23, 2004

Related U.S. Application Data
(60) Provisional application No. 60/483,747, filed on Jun. 30, 2003.

(30) Foreign Application Priority Data
Jun. 26, 2003 (SE) 0301913-0

(51) Int. Cl. G06F 17/60

(52) U.S. Cl. 705/19

(57) ABSTRACT

Comprising a database (3) and first terminals, which are located in shops (1) and connected to the database (3) and provided with equipment for inputting purchase data. The system is arranged to create an electronic cheque on the basis of said data.

The system comprises printers for receipts (7) and computer programs for creating a reference (8) for identifying each respective receipt and, when printing out, stating this reference on the receipt and connecting said reference for a receipt (7) and the corresponding electronic cheque and storing electronic cheques and the references belonging to them in the database.

Said receipts (7) have areas (9,10,11) for entering personal details. The receipts (7) serve as refund receipts for value-added tax and for customs inspection. The system comprises refund stations (5) where the consumer receives his refund.

Second terminals are linked to the database (3) and provided with equipment for gathering references (8) from receipts (7) and gathering electronic cheques belonging to said references (8) from the database (3), whereafter a receipt (7) can be compared with the corresponding electronic cheque.

### TECHNICAL FIELD

The present invention concerns systems for handling of refunding of value-added tax to a consumer who has purchased goods in another tax area than the area where he is resident, for example in another country than his country of residence.

### BACKGROUND ART

Persons who travel to another country than their country of residence may have the right to a refund of so-called value-added tax when they purchase goods or services abroad. This type of tax is found in many countries and the rate of tax can vary in different countries. In Europe the tax rate for most countries is over 10%. For example, the United Kingdom has so-called VAT (Value-added Tax) at 17.5% on most articles. In Sweden and Denmark this tax is as much as 25% but is somewhat lower for certain goods and services. In Canada this tax on goods and services is 7% and certain provinces have a supplement for provincial taxes. In the USA most states have regional taxes in the order of 1-10%.

With the purpose of stimulating exports, these value-added taxes can in many countries be refunded to persons who are resident outside the country.

Hitherto, it has been very complicated for tourists and other visitors to a foreign country with value-added tax to obtain a refund of this tax. Ways of carrying out the refund vary between different countries. In some countries, visitors are allowed to apply for a refund when they leave the country, for example in duty-free sections at airports or in duty-free stores near borders. However, the visitor must gather receipts and decide which purchases are entitled to a refund. The visitor must also complete forms in foreign languages, which forms must be checked by customs officials at the same time as the purchases must be presented. The visitor must therefore queue at a refund counter and there receive the refund, often in the currency of the country in question, which in turn means that the visitor must later stand in an exchange queue in order to receive his refund in the desired currency.

One example of a process for refunding value-added tax is practised in Canada. According to this process, a person who has visited the country must post from outside the country a refund form together with original receipts for all purchases. Thereafter, it takes at least six weeks before the Canadian agent handles the case and sends the refund. The refund is paid in Canadian dollars and therefore when the visitor receives the cheque, he must also change it to the currency of his own country.

Another way of refunding value-added tax (VAT) is practised in the United Kingdom. For each purchase for which a refund is possible, the visitor must prove his right to a refund by presenting his passport to the sales assistant. Certain retailers may also demand a minimum purchase before a refund can be received. Visitors must then in the shop complete a special refund form which is supplied by the retailer.

When the visitor leaves the European Community, all refund forms and corresponding goods must be presented to a customs official and the visitor receives a customs stamp on the above-mentioned form. If the visitor neglects to certify the refund form at the customs, he will have no further opportunity of receiving a refund.

Once outside the European Community, the visitor must post a customs-stamped refund form to each shop where he made a purchase. The retailer will then deduct a fee and send a cheque in Euros for the remaining amount to the customer, who then can change it to a currency that can be used in his homeland.

Other countries have other special rules that must be fulfilled in order to obtain a refund of value-added tax.

As can be seen from the above, it is possible for individuals to receive a refund of value-added tax which has been paid when purchasing goods in foreign countries. However, as has been seen, this is extremely complicated for certain countries. Furthermore, the rules vary, which makes it considerably more difficult for persons visiting several countries during a trip.

The purpose of enabling value-added tax to be refunded to people who are resident in another country is of course to try to stimulate export of goods. With the aim of preventing tax fraud, different countries have chosen, as has been exemplified above, to introduce different rules which must be met in order to allow foreign visitors to receive refunds of value-added tax.

There exist service companies, which have set up businesses to enable easier handling of refunds of value-added tax for both tourists and shops. In shops which are collaborating with these service companies, tourists are given refund forms which have to be completed with certain personal details. Goods and forms are presented at customs and forms are provided with the requisite customs stamp. The above-mentioned companies have service points at international airports and at border stations where tourists can obtain their refund directly in the desired currency. The company then takes care of all paperwork and bills the shops.

If a customer forgets or does not have time to visit the above-mentioned service points for refunding value-added tax, the customer can also send the requisite documents to the service company afterwards. The service company can then, with the aid of the documents, deposit the tax refund in the customer's bank account or the like.

These service companies considerably simplify the procedure for tourists and doubtless considerably stimulate sales for the participating shops.

However, there is a need for further simplification for both shop-owners and tourists.

There is still a great deal of time-consuming paperwork for the shops, which, for each new customer who is perceived to be a tourist or states himself to be a tourist, must furnish refund forms and in addition must explain to the tourist how to fill them in. This time-consuming practice reduces the flow of paying customers through the shop and there is a great need to simplify the routines and reduce the paperwork.

It is still complicated for the tourists because they have to complete a new form in each new shop.

WO 00/42546 suggests a system for simplifying the refunding of value-added tax. The said system comprises an advanced transaction card, which is intended to cooperate with card terminals to execute the purchase transaction and generate transaction data. An application for a tax refund is stored directly on the transaction card, which is arranged to calculate the tax refund corresponding to the entered purchase data. However, the system suggested in WO 00/42546 is not realistic because it does not take into account the requirements of different countries for checking of transactions regarding refunding of tax. Essential data, such as the cardholder's passport number and home address, is also difficult to store on the transaction card since these details must be able to be changed, for example if the card holder changes his home address. For the individual consumer it is regarded to be inconvenient to have yet another “credit card” to look after and carry with one on trips abroad.

A further problem with the system described above where refund forms provided with custom stamps are presented at a refund point for payment of a refund is that the service company is not able to check the authenticity of the purchase sum, which could have been manipulated. There is no opportunity to check for fraud or monitor to what extent it arises.

As is evident from the above, there is a great need, from the point of view of both retailers and consumers, to improve the present system for refunding value-added tax to tourists.

### DISCLOSURE OF INVENTION

The present invention is characterised in, that the system comprises a central database,
that the system comprises first terminals, which are placed in shops that are connected to the system, and which are connected to the database via a network,
that said first terminals are provided with equipment for entering purchase data for each purchase occasion, that the system has programs for adding system-generated data to said purchase data,
that the system is arranged to create an electronic cheque for said purchase occasion on the basis of said data,
that the system comprises printers for printing receipts for said purchase occasions, which receipts comprise said purchase data and said system-generated data, that the system comprises computer programs for creating a reference for identifying each respective receipt and, in connection with the printing of the receipt, stating this reference on the receipt and connecting said reference for a person's receipt and the corresponding electronic cheque for a person's purchases and storing cheques and the references belonging to them in the database,
that said receipts are designed with areas for entering personal details such as name, address and passport number, that said receipts are also intended to serve as refund receipts for repayment of value-added tax and for this purpose to be carried by each consumer for presentation in connection with customs inspection, that the system comprises refund stations where the consumer receives his refund on presentation of a receipt provided with a customs stamp,
that the system comprises second terminals, which are connected to the database via the system's network, that said second terminals are provided with equipment for gathering said references from consumers' receipts, that the second terminals are arranged to gather an electronic cheque(s) belonging to said references from the database, whereafter a consumer's receipt can be compared with the purchase data for the corresponding electronic cheque in order to check the accuracy of the refund that is paid out.

The use of electronic cheques shortens the lead time with respect to the shop. The electronic cheque is connected via a unique reference to the receipt for each respective purchase. The customer can then complete the receipt at his convenience with requisite tourist data for customs inspection. Thus, with the system in accordance with the invention, the shop can avoid all work connected with entering of tourist data. Connecting the purchase receipt and the electronically filed cheque to a common reference enables any forgery of receipts to be discovered. The system in accordance with the invention is therefore considerably safer than previously known systems.

According to one embodiment, the invention is further characterised in that the first terminal is arranged to output said receipt via the standard printer of the first terminal, said reference being stated on the receipt and stored in the central database, linked to the electronic cheque for said purchase on a purchase occasion, and in that the references for all of a consumer's purchase occasions are intended to be inputted in the second terminals in order to produce the consumer's purchase data from the database.

According to another embodiment, the invention is characterised in that the second terminals are arranged in centres in which said inspection occurs.

According to an alternative embodiment, the invention is characterised in that the second terminals are also arranged in one or several of said refund points and the inspection of the authenticity of a receipt can then be carried out at such refund points equipped with second terminals before value-added tax is repaid.

Further embodiments of the invention are evident from the claims below.

### DESCRIPTION OF THE FIGURES

The invention shall be described in more detail below with reference to embodiments shown in the attached drawings, in which

FIG. 1 shows a block diagram of an embodiment of the system according to the invention,

FIG. 2 shows an example of a purchase receipt being part of the system.

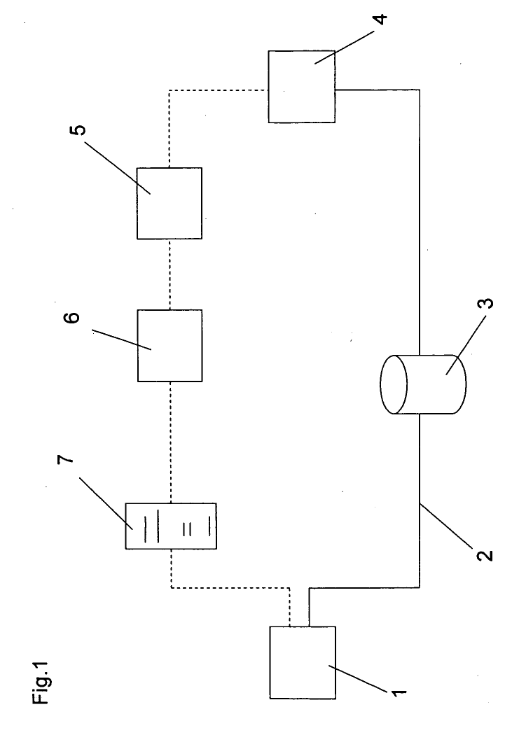

In FIG. 1 a shop 1 has been shown, which shop is connected to a system in accordance with the invention and which here represents a shop in one country. The shop is provided with a first terminal, which, via a network 2 is connected to a central database 3 forming part of the system. This is connected via the network 2 to a second terminal located in a centre 4 (a “back-office”). The system flow also comprises refund points 5 and customs stations 6.

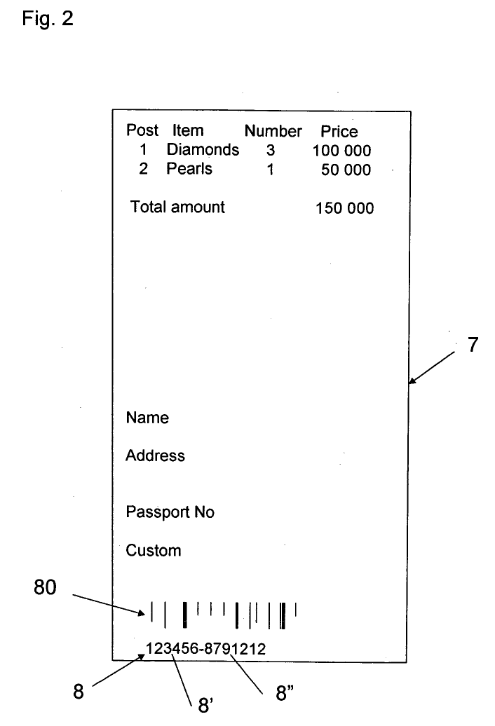

FIG. 1 also shows in schematic form a receipt, the function and design of which will be described in more detail below with reference to FIG. 2.

The embodiment shown in FIG. 1 is greatly simplified for the sake of clarity. The aim is of course that a large number of shops 1 and stores in different countries will be connected to the system, in the same way as the present system is part of an international flow. Correspondingly, a large number of customs stations 6 and a large number of refund points 5 will be included.

The following describes how the system works, with reference to several purchase examples.

A purchase in shop 1 is registered in a first terminal (shop terminal), belonging to the system. This terminal can be formed in various ways. Suitably, the shop terminal is small and compact in format, similar to credit card terminals found in shops. The actual registration of the purchase in the shop terminal can take place even before the person in question has been identified as a tourist with the right to a refund of value-added tax.

The shop terminal has equipment, for example a keyboard and a bar code reader for inputting purchase data.

A receipt for the purchase in question with accompanying purchase data is created. This receipt 7, which is shown in FIG. 2, is constituted by a refund receipt which has been printed by the standard printer of the terminal on standard paper. This refund receipt is entirely related to the purchase in question. A reference number 8, consisting of, for example, a serial number 8′ and a code 8″ can be given on the refund receipt 7. In the shown embodiment the reference number is also given in the form of a bar code 80. The purchase data registered on the receipt 7 is simultaneously stored in the form of an electronic cheque, which electronic cheque is given the same reference number as that stated on the receipt. Thus, the reference number is also connected to an electronic cheque regarding the purchase in question.

The receipt 7 contains areas 9, 10, 11 for entering tourist data such as name, home address and passport number. In order to be able to receive a refund of value-added tax for all of his purchases, the tourist must save the receipts for all of his purchases.

The information registered in the shop terminal and the electronically linked reference number, which connects the receipt 7 and thus the tourist to the purchase in question, are transferred via the network 2 to the central database 3. At the time of purchase the shop assistant verifies electronically that a refund of value-added tax can be carried out for the purchase in question.

Purchase information and relevant reference numbers are stored in the central database.

The various steps in the system in accordance with the invention are laid out in brief below.
1. A tourist purchases 3 diamonds in shop 1 for 100 000 SEK and a pearl for 50 000 SEK. The VAT on the total purchase sum in shop 1 is 37 500 SEK.
2. The customer is identified as a tourist by the sales assistant or on the basis of his own information.
3. The purchase is registered in a shop terminal. This can occur before or after the person is identified as a tourist.
4. A refund receipt is printed by the terminal's in built printer whereupon a reference to the current purchase in the form of a reference number is given on the receipt.
5. An electronic cheque for the purchase in question is created and given the same reference number as the corresponding receipt.
6. The electronic cheque with the appropriate reference number is transferred via network 2 to the central database 3.
7. The sales assistant verifies electronically that a tax refund can be given on the purchase, the electronic cheque for which is linked to the present reference number.
8. Purchase details and a reference in the form of a reference number on the refund receipt are stored in the central database.

The degree of detail in the central database is decided by legal and contractual requirements. For example, the following purchase details can be stored in the database.

| Shop | Number | Item | Price | VAT | Reference number |
|---|---|---|---|---|---|
| 1 | 3 | Diamonds | 100,000 | 25,000 | 123456-8791212 |
| 1 | 1 | Pearls | 50,000 | 12,500 | 123456-8791212 |

The same tourist later goes into a watchmaker's and buys a watch for 150 000 SEK of which 37 500 is VAT. The shop assistant checks that a refund of value-added tax can be carried out for the purchase in question and a receipt for that purchase is printed out. The receipt for the watch is given a reference number that is specific for this purchase transaction and the purchase information and relevant reference number are saved in the central database.

The database now contains the following information:

| Shop | Number | Item | Price | VAT | Reference number |
|---|---|---|---|---|---|
| 1 | 3 | Diamonds | 100,000 | 25,000 | 123456-8791212 |
| 1 | 1 | Pearls | 50,000 | 12,500 | 123456-8791212 |
| 2 | 1 | Watch | 150,000 | 37,500 | 173897-3715192 |

In order to receive the tax refund, the goods must be presented at customs at an airport or at a border crossing. For the purpose of a tax refund, the tourist must keep all of the purchase receipts in order.

The custom official's verification can comprise, for example,: export date, place of customs inspection and the signature of the customs official.

After verification at customs of the right to a refund, the customer, or tourist, can seek out a refund point 5 forming part of the system. These refund points are located in connection with customs stations, for example in the shopping area in an airport.

The following occurs at the refund point:
1. A customer, a traveller returning from abroad, presents his receipts. The identity and passport number of the customer are checked and compared with details on each receipt.
2. A check is made to establish if customs stamps exist for the purchase in question.
3. If all the details are correct and customs stamps are in order, a tax refund is paid out for all approved purchases.
4. After the payment has been carried out, details of the transaction are sent to the back-office

In the system as a whole, considerable simplifications and improvements are achieved compared with known systems. The rate of customer flow in shops increases considerably. Manual handling of receipts and forms is reduced to a great extent for the shops.

Naturally, the customer does not need to visit the refund point in person but can send in the relevant documents, whereupon the money can be paid out. If the refund points are located, for example, at an airport they may be closed. Alternatively, the customer may not have time to go there or perhaps cannot find the refund point or may forget to claim his refund.

Refund of value-added tax can be carried out in different ways depending on the possibilities available at airports and in connection with customs stations and also depending on the customer's wishes.

Refunds can be carried out at manned refund points, which can be located in connection with customs checkpoints or at other suitable locations where travellers pass.

The customer can also send receipts with customs stamps by post to the service company that administers the refund, whereupon the service company attends to the payment in the desired way.

All the receipts are sent from each refund point to a back-office 4, which back-office has access to the database 3 via the network 2. At the back-office a manual check is carried out as to whether purchase data for each receipt and accompanying right to a tax refund correspond with the details stored in the database.

It is possible that some of the refund points 5, in addition to the back-office 4, can be equipped with said second terminals, which via the network are connected to the central database 3. If there is a connection to the central database, service staff at the refund points can have access to all information stored in the database and, before a refund is paid out, can thus check by means of computer monitors individual customers' right to a refund of value-added tax on purchases made abroad

The reference number can, as mentioned above, consist of a serial number and a code. It is also conceivable to have reference numbers in the form of only a serial number. Alternatively, the reference number can include numbers which represent one or several variables, such as shop, terminal, country, etc. The purpose of the reference number is, as mentioned above, to link the receipt with the signed tourist data to the purchase information in the database.

The invention is not limited to the embodiments described above. A number of variations are possible within the scope of the following claims.

What is essential is that security against fraud increases through the establishment of a reference linked to personal details on a receipt, which reference is linked to a separate electronic cheque.

1. System for handling of refund of sales tax, such as value-added tax to a consumer who has purchased goods in another tax area than the area where he is resident, for example in another country than his country of residence,
characterized in
that the system comprises a central database (3),
that the system comprises first terminals, which are placed in shops (1) that are connected to the system, and which are connected to the database (3) via a network,
that said first terminals are provided with equipment for entering purchase data for each purchase occasion, that the system has programs for adding system-generated data to said purchase data,
that the system is arranged to create an electronic cheque for said purchase occasion on the basis of said data,
that the system comprises printers for printing receipts (7) for said purchase occasions, which receipts comprise said purchase data and said system-generated data,
that the system comprises computer programs for creating a reference (8) for identifying each respective receipt and, in connection with the printing of the receipt, stating this reference on the receipt and connecting said reference for a person's receipt (7) and the corresponding electronic cheque for a person's purchases and storing electronic cheques and the references belonging to them in the database,
that said receipts (7) are designed with areas (9,10,11) for entering personal details such as name, address and passport number, that said receipts (7) are also intended to serve as refund receipts for repayment of value-added tax and for this purpose to be carried by each consumer for presentation in connection with customs inspection, that the system comprises refund stations (5) where the consumer receives his refund on presentation of a receipt (7) provided with a customs stamp,
that the system comprises second terminals, which are connected to the database (3) via the system's network (2), that said second, terminals are provided with equipment for gathering said references (8) from consumers' receipts (7), that the second terminals are arranged to gather an electronic cheque(s) belonging to said references (8) from the database (3), whereafter a consumer's receipt (7) can be compared with the purchase data for the corresponding electronic cheque in order to check the accuracy of the refund that is paid out.

2. System in accordance with claim 1,
characterized in that the first terminal is arranged to output said receipt (7) via the standard printer of the first terminal, said reference (8) being stated on the receipt (7) and stored in the central database (3), linked to the electronic cheque for said purchase on a purchase occasion, and in that the references (8) for all of a consumer's purchase occasions are intended to be inputted in the second terminals in order to produce the consumer's purchase data from the database (3).

3. System in accordance with any one of the preceding claims, characterized in that the second terminals are arranged in centres (4) in which said inspection occurs.

4. System in accordance with claim 3,
characterized in that the second terminals are also arranged in one or several of said refund points (5) and the inspection of the authenticity of a receipt (7) can then be carried out at such refund points (5) equipped with second terminals before value-added tax is repaid.

5. System in accordance with any one of the preceding claims, characterized in that said reference number (8) is constituted by a serial number.

6. System in accordance with any one of claims 1-4, characterized in that said reference number (8) is constituted by a serial number (8′) and a code (8″).

7. System in accordance with any one of claims 1-4, characterized in that said reference number (8) comprises one or several identification numbers for, for example, shop, terminal and country.

8. System in accordance with claim 7, characterized in that the reference number (8) also comprises a code.

9. System in accordance with any one of the preceding claims, characterized in that at least some of said second terminals are provided with equipment for reading reference numbers (8) from consumers' receipts (7).
